(19) United States
(12) Patent Application Publication
(10) Pub. No.: US 2004/0003717 A1
(43) Pub. Date: Jan. 8, 2004

(54) Use of product gas recycle in processing gases containing light components with physical solvents

(76) Inventor: Thomas K. Gaskin, Spring, TX (US)

Correspondence Address: Raymond Reese, HOWREY SIMON ARNOLD & WHITE, LLP, 750 Bering Drive, Houston, TX, 77057-2198, US

(21) Appl. No.: 10/613,561

(22) Filed: Jul. 3, 2003

Related U.S. Application Data
(60) Provisional application No. 60/394,198, filed on Jul. 5, 2002.

(51) Int. Cl. B01D 53/14

(52) U.S. Cl. 95/176; 95/237; 96/234

(57) ABSTRACT

A process for separating the components of a multi-component gas stream is disclosed. The multi-component gas stream is contacted with a solvent in an extractor to produce an overhead stream enriched with unabsorbed component(s) and a rich solvent bottoms stream enriched with absorbed component(s). The rich solvent bottoms stream is then flashed regenerate lean solvent and to recover the absorbed component(s) as an overhead stream, which is compressed to produce a product stream. The regenerated solvent is recycled to the extractor. A portion of the product stream is also recycled to the extractor to improve the overall purity of the product stream.

### CROSS-REFERENCE TO RELATED APPLICATIONS

This applications is a non-provisional application of provisional application No. 60/394,198, filed Jul. 5, 2002, the entire contents of which are hereby incorporated herein by reference.

### FIELD OF THE INVENTION

The invention relates to the field of chemical processing and, more specifically, to the processing of hydrocarbon gas streams. In particular, a method and apparatus for separating the components of a hydrocarbon gas stream is disclosed.

### BACKGROUND OF THE INVENTION

Many hydrocarbon gases such as natural gas, cracked gas, or refinery off gas contain one or more light components that either contaminate the main gas or that are themselves valuable if they can be separated from the main gas stream. Such light gases include nitrogen, helium, and hydrogen. As described below, a number of economic considerations make it desirable to separate these light gases from a hydrocarbon gas stream.

For example, contamination of natural gas with one or more light components is particularly common. Natural gas is a mixture of hydrocarbons, including methane ethane, propane, butane and pentane. Natural gas can also contain nitrogen, helium, and acid gases such as carbon dioxide and hydrogen sulfide. Nitrogen is sometimes a natural component or may derive from nitrogen injections utilized for reviving oil wells in suitable formations. Helium occurs naturally in a small portion of natural gas reservoirs. Natural gas must meet certain criteria for acid gas content, heating value, dew point, and total inert content before the natural gas can be transported and marketed. Nitrogen content is often limited to less than 2-4% molar. Nitrogen must therefore be removed from natural gas containing more than the specified amount or the natural gas cannot be transported and marketed.

Natural gas is also produced in association with crude oil production as associated gas. This associated gas may contain naturally occurring nitrogen or may contain injected nitrogen used to enhance oil recovery. Associated gas must meet the same criteria as natural gas if the associated gas is to be transported and marketed.

Refinery and chemical plant streams often contain a number of light components such as nitrogen and hydrogen. Hydrogen is commonly contained in gas streams in refinery units. Hydrogen is added to some refinery operations and is produced as a side-product in other refinery unit operations. It is often desirable to separate this hydrogen from the refinery off gas because removed and recovered hydrogen can be recycled within the facility or sold, typically for a higher value than the heating value of the hydrogen in a refinery or chemical plant hydrocarbon stream. Likewise, removing nitrogen from the plant stream increases the heating value of the remaining hydrocarbon stream and potentially increases the stream's value as a fuel stream.

Separation of light components such as hydrogen or nitrogen from heavier components such as methane and ethane can increase the value of either or both of the resulting separate streams. Existing technologies for performing such separations, include the use of selective membranes, adsorption systems such a pressure swing adsorption, and systems that utilize very low temperatures (cryogenic plants) such as expander, Joule-Thompson, or cascaded refrigeration plants. Absorption using a physical solvent to remove the heavier components and therefore separate them from the light components, a process known as the Mehra Processsm, can be employed. The Mehra Process is described in several U.S. patents, including U.S. Pat. Nos. 4,623,371, 4,832,718, 4,833,514, and 5,551,952, which are hereby incorporated herein by reference. These patents describe systems for absorption/flash regeneration systems for removal of light components such as nitrogen or hydrogen from heavier components such as methane or ethylene. An improvement to these processes is also described in United States Provisional Application No. 60/339,591 (incorporated herein by reference) by Thomas K. Gaskin, which addresses use of stripping gas to enhance the performance of flash regeneration systems. A further improvement is describe in United States Provisional Application No. 60/359,383 (incorporated herein by reference) by Thomas K. Gaskin, which describes the use of a vapor recycle in the flash generation of solvent absorption systems for hydrocarbon gas heating value reduction.

In this process, the heavier components are absorbed away from the light component(s) using a circulating physical solvent. Reducing the pressure of the rich solvent in a flash separator releases the heavier component and regenerates the solvent for recirculation to the absorber. The physical solvent may be a liquid chosen for its physical properties, one property being that it is heavier than the component to be absorbed from the light component. The physical solvent can also be made up entirely of the heaviest components of the feed gas stream. These heaviest components are those that do not readily vaporize in the flash regeneration of the circulating solvent. These absorption processes are characterized in that a feed stream comprising multiple components enters the process and two or more streams, each being enriched in at least one of the components, leaves the process. Any improvement to the process that results in increasing the purity of one or more of the exiting streams will be appreciated as a technical contribution to the art.

### BRIEF SUMMARY OF THE INVENTION

One aspect of the present invention is a process for separating the components of a multi-component gas stream. The process comprises contacting the gas stream with a solvent in an extractor to produce an overhead stream that is enriched in at least one of the components and a solvent bottoms stream that is enriched in at least one of the other components. The enriched solvent bottoms stream is then flashed in at least one reduced pressure stage to release the absorbed component(s) from the solvent, thereby regenerating lean solvent and providing the released component(s) as an overhead gas stream. The released component(s) stream is compressed to produce a product stream. According to the present invention, a portion of the product stream is recycled to the extractor. Recycling a portion of the recovered product stream back to the extractor increases the purity of the total recovered product.

Returning a portion of the total recovered product back to the extractor is counter-intuitive because the aim of the extraction step was to separate this component from the feed stream. Surprisingly, recycling a portion of the product stream back to the extractor provides more complete separation of the light gas components from the heavier components during the extraction step and allows a better separation from a process that requires fewer pieces of equipment than other process that do not include this recycle step.

### BRIEF DESCRIPTION OF THE DRAWINGS

FIG. 1 shows a prior art process for separating the components of a gas stream.

FIG. 2 shows a prior art process for separating the components of a gas wherein the process includes recycling a portion of the overhead gas stream from a flash separator back to the extractor.

FIG. 3 shows a process according to the present invention for separating the components of a gas stream wherein the process includes recycling a portion of the total absorbed heavier component back to the extractor.

FIG. 4 A process according to the present invention for separating the components of a gas similar to the process of FIG. 3 but also providing a means for using a portion of the separated light component as stripping gas to aid regeneration of the solvent.

### DESCRIPTION OF PREFERRED EMBODIMENTS

It should be understood that pipelines are in fact being designated when streams are identified hereinafter and that streams are intended, if not stated, when materials are mentioned. Moreover, flow control valves, temperature regulator devices, pumps, compressors, and the like are understood as installed and operating in conventional relationships to the major items of equipment which are shown in the drawings and discussed hereinafter with reference to the continuously operating process of this invention. All of these valves, devices, pumps, and compressors, as well as heat exchangers, accumulators, condensers and the like, are included in the term “auxiliary equipment”. The term, “absorber,” is conventionally employed for a gas/solvent absorbing apparatus, but when utilized in the process of this invention with a physical solvent, it is considered to be an “extractor.” As used herein, “extractor” refers to any apparatus known in the art in which a gas is contacted with a solvent to absorb part of the gas into the solvent. According to certain embodiments, the extractor may include internals such as plates, packing, baffles and the like, to promote mass transfer. As used herein, referring to a process step as producing a stream that is enriched in a certain component or components means that the fractional percentage of that component or components in the produced stream, relative to the other components, is greater than the relative percentage of that component or components in the stream entering the process step.

One aspect of the present invention is a process for separating the components of a multi-component gas stream. The process comprises contacting the gas stream with a solvent to produce an overhead stream that is enriched in at least one of the components and a rich solvent bottoms stream that is enriched in at least one of the other components. This contacting step is typically performed in an extractor. Typically the solvent absorbs the heavier component(s) of the multi-component stream, leaving the lighter component(s) as the overhead stream. The enriched solvent bottoms stream is flashed in at least one reduced pressure stage to release the absorbed component(s), thereby regenerating the solvent and providing the absorbed component(s) as an overhead stream. The regenerated solvent is recycled to the extractor.

It has been recognized that although the absorbed/released component(s) are typically the heavier component(s), often some amount of the light components co-absorb into the solvent and are therefore also released during the flash stage. This contamination of the heavier gas stream by the lighter component(s) is typically undesirable. One solution to this contamination has been to subject the enriched solvent to multiple flash stages and to recycle a portion of the gas released from one or more of the early flash stages back to the extractor. As explained further below, the gas from the early flash stage(s) is typically more contaminated with lighter components than is the gas released from the later flash stage(s). This recycle step has the effect of removing the lighter component from the product stream (because the lighter component is recycled back to the extractor). However, this recycle step requires that additional flash stages and additional compressors be included in the process.

The present invention achieves a product stream that is less contaminated with light component(s) without requiring additional flash and compressor stages. According to one the present invention, a portion of the final product stream is recycled to the extractor. Recycling a portion of the product stream back to the extractor is counter-intuitive when one considers that the purpose of the extractor is to separate the absorbed from the unabsorbed components. Furthermore, the product stream may already be within the specified purity with regard to contamination by the lighter component(s). It would therefore not be obvious to sacrifice a portion of this stream. Surprisingly, it has been discovered that recycling a portion of the product stream back to the extractor provides more complete separation of the light gas components from the heavier components during the extraction step, thereby providing a higher-purity product stream. Additionally, the process of the present invention requires fewer pieces of equipment than other process that do not include this recycle step.

The process of the present invention is generally applicable to any multi-component gas stream, wherein the different components of the gas stream have different solubilities in a hydrocarbon solvent. The multi-component gas stream will typically comprise one or more hydrocarbons. Generally, the heavier component(s) of the gas stream will preferentially absorb into the solvent, generating a solvent bottoms stream that is enriched in the heavier component(s) and an overhead stream that is enriched with the lighter component(s). For example, the multi-component gas stream can contain nitrogen and methane. Contacting such a gas stream with a solvent, according to the present invention, will produce a solvent stream that is enriched in methane and an overhead stream that is enriched in nitrogen. If the multi-component gas stream comprises hydrogen and methane, contacting the stream with a solvent will produce an overhead stream enriched with hydrogen and a solvent bottoms stream enriched with methane. More complicated multi-component gas streams are possible, for example, gas streams comprising components selected from hydrogen, helium, nitrogen, methane, ethylene, ethane, heavier saturated and unsaturated hydrocarbons and mixtures thereof.

The solvent can itself be one of the components of the multi-component gas stream, for example, the heaviest component of the gas stream. Alternatively, the solvent can be an external solvent that is added to the process. Exemplary solvents include paraffinic solvents, naphthenic solvents, iso-paraffinic solvents, and aromatic solvents. According to one embodiment, the multi-component gas stream is countercurrently contacted with the solvent in the extractor. According to one embodiment, the feed gas and/or circulating solvent is cooled using a refrigerant stream.

Aspects of the present invention can be better understood with reference to the drawings and the following discussion of the embodiments depicted in the drawings. Where numbered components are not specifically discussed in the text, they can be assumed to have the same identity and purpose as the corresponding numbered component in the discussion of the previous or prior drawings.

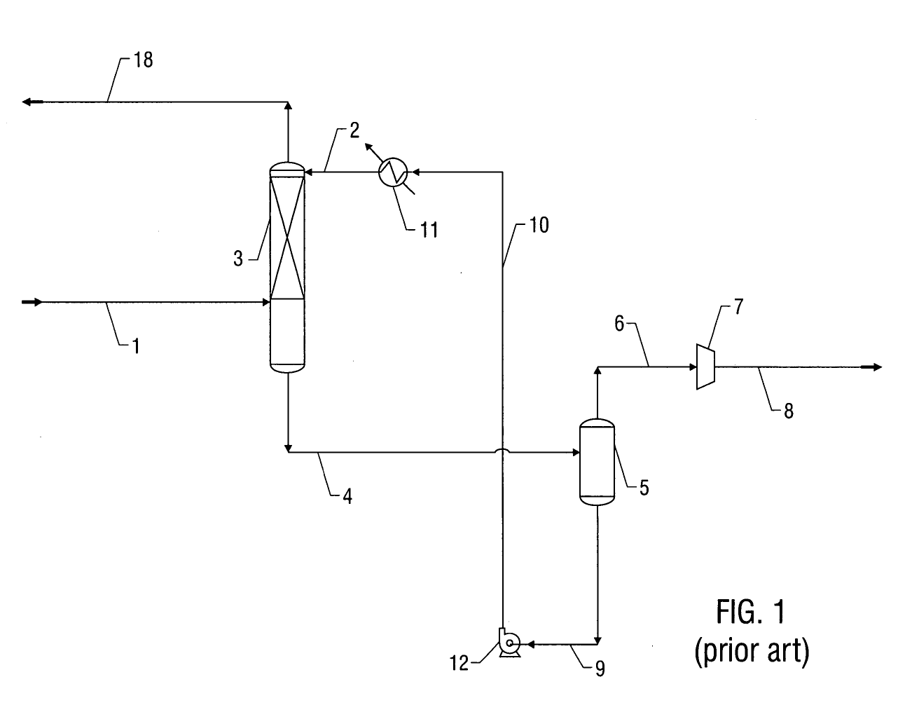

FIG. 1 shows a prior art process lacking any gas recycle step. According to the process of FIG. 1, hydrocarbon feed gas 1 is counter-currently contacted with lean solvent 2 in extractor 3, generating an overhead stream 18 and a rich solvent bottoms stream 4. The rich solvent bottoms stream 4 can is directed to one or more flash separators 5. The number of separators can vary. According to one embodiment, there is a single flash separator 5. The component absorbed in the solvent is released in separator 5, and is separated as vapor stream 6. While only one flash stage is depicted in FIG. 1, multiple separators could be used. The pressure of stream 6 is elevated via compressor 7, yielding stream 8 as a product stream of the process. The regenerated lean solvent leaves separator 5 as a liquid stream 9 and is returned to extractor 3 as stream 10 via pump 12. Lean solvent stream 10 may be cooled in solvent cooler 11 prior to re-entering the extractor 3. If the multi-component gas stream 1 entering the process of FIG. 1 comprises methane and nitrogen, for example, natural gas contaminated with nitrogen, then stream 18 will be enriched with nitrogen and stream 8 will be enriched with methane. However, stream 8 is often contaminated with a significant amount of nitrogen because nitrogen co-absorbs with methane into the solvent. Ideally, contacting stream 1 with solvent would result in overhead stream 18 being nitrogen and stream 4 being solvent enriched only with absorbed methane. However, under real working conditions, feed composition and operating conditions result in an undesirable amount of nitrogen being co-absorbed into the solvent stream 4 along with the desired absorbed component, i.e., methane.

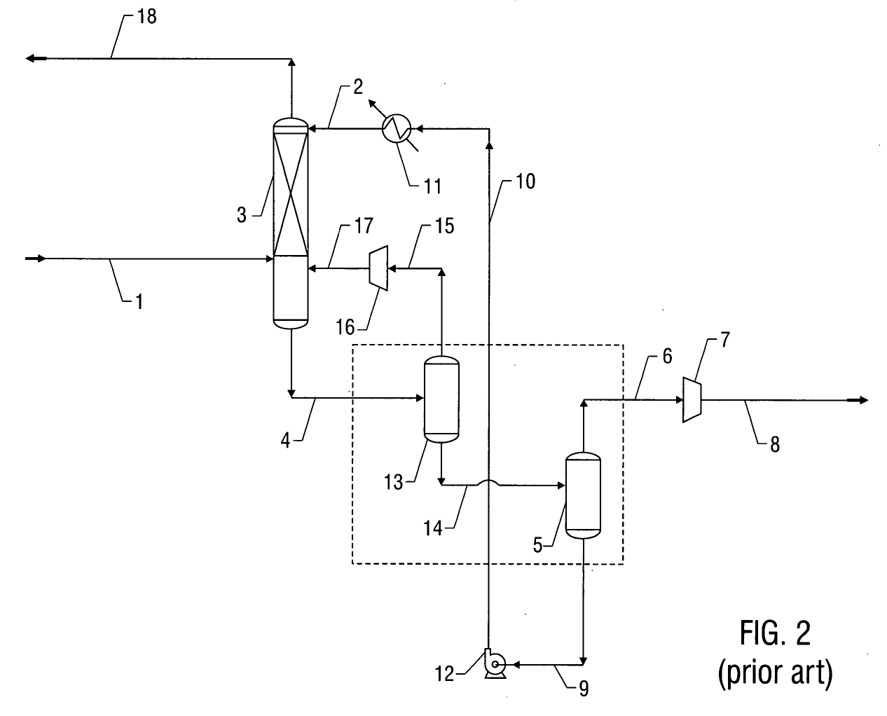

FIG. 2 shows a prior art process that reduces the amount that the product stream is contaminated with co-adsorbed light components. The process of FIG. 2 utilizes two flash-regeneration separators, intermediate flash 13 and final flash 5. Overhead stream 15 from intermediate flash 13 is recompressed by recycle compressor 16 and recycled to extractor 3. Final flash 5 generally operates at a lower pressure than intermediate flash 13. Because nitrogen is a lighter component than methane, intermediate flash 13 preferentially releases the co-absorbed nitrogen and preferentially leaves the desired methane in the enriched solvent 14. Nitrogen rich gas stream 15 is recompressed and returned to extractor 3, preferably at a point in the extractor that is equal to or below the feed gas stream 1. This results in stream 18 being further enriched with nitrogen. Removing co-absorbed nitrogen from stream 4 results in final product stream 8 to containing less nitrogen. The process according to FIG. 2 provides a higher product stream but requires an additional nitrogen compressor (16) and an additional flash stage (13).

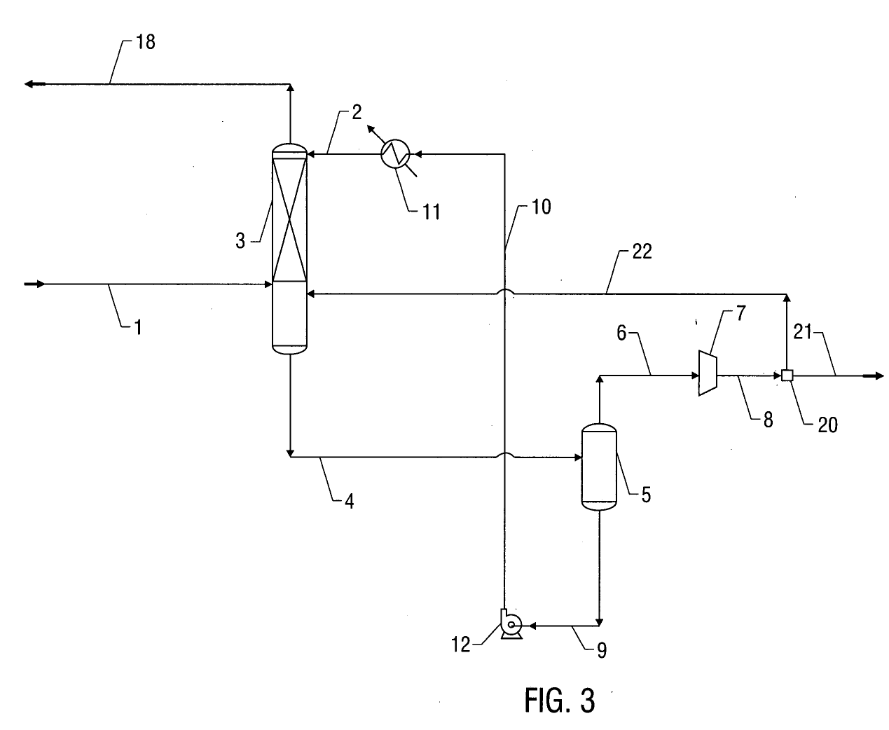

FIG. 3 depicts an embodiment of the present invention, wherein a portion of the absorbed/released component(s) is recycled to extractor 3 from further along the process stream. A multi-component gas stream 1 is counter-currently contacted with lean solvent 2 in extractor 3, generating an overhead stream 18 and a rich solvent bottoms stream 4. The rich solvent bottoms stream 4 is directed to one or more flash separators 5. The number of separators can vary. The absorbed component is released as stream 6 by separator 5. This stream is compressed via compressor 7 to a become stream 8. The regenerated lean solvent leaves separator 5 as liquid stream 9, is returned via pump 12 to extractor 3 as stream 10. Lean solvent stream 10 can be cooled via solvent cooler 11 prior to re-entering the extractor 3. According to the embodiment depicted in FIG. 3, a portion of the product stream 8 is diverted via split 20 and recycled to extractor 3 as stream 22. Stream 22 typically enters the extractor at a point equal to or below the feed stream 1. The portion of product stream 8 that is not recycled, stream 21, is the net product stream. In the case of separation of nitrogen and methane, recycle of a portion of the product stream 8 is beneficial even though that stream may already meet product specifications for remaining nitrogen content. This is because recycling a portion of this stream to extractor 3 adjusts the composition in the bottom of the extractor, further enriching stream 4 with methane. This is a different approach than in FIG. 2, where stream 15 from the first flash separator may be enriched in nitrogen. This nitrogen-rich stream is likely to cause the nitrogen content of the total methane product to exceed specification if it were included in the product methane. According to the embodiment depicted in FIG. 2, nitrogen rich stream 15 is recycled to avoid including the nitrogen in the methane product. This requires a dedicated recycle compressor (shown as 16 in FIG. 2). Contrarily, in FIG. 3, a methane rich stream 22 prevents the flashed vapors from being off-specification for nitrogen in the methane product. The recycle method used in the present invention eliminates the need for the dedicated recycle compressor and can also eliminate the need for a first flash vessel.

The embodiment of FIG. 3 demonstrates how the present invention can be realized via a simple retrofit of a prior art process according FIG. 1. The retrofit comprises a means of splitting a portion of product stream 8 and redirecting it back to separator 3.

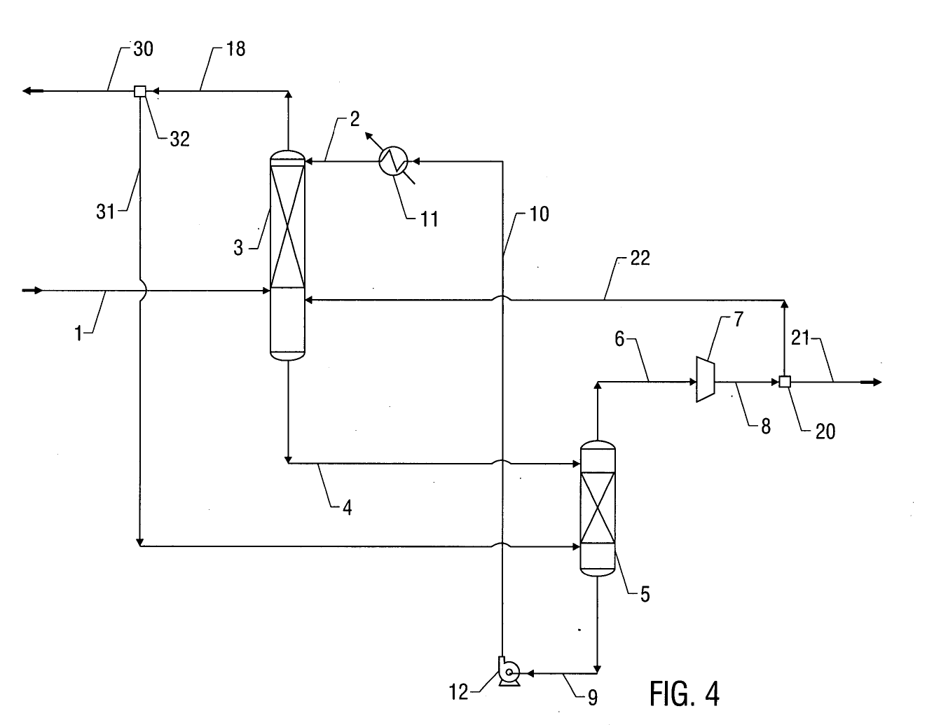

An alternative embodiment of the present invention is shown in FIG. 4. In this embodiment, a portion of the light, unabsorbed component 18 is diverted via splitter 32 and directed as stream 31 to flash separator 5, where it is used a stripping gas. Stripper columns may also be used instead of flash vessels and multiple stripper columns or flash separators may be used. Introduction of the light component (nitrogen, for example) causes more of the absorbed component (methane, for example) to be stripped from the circulating solvent, allowing higher percent recovery of the absorbed component (methane) by allowing circulation of a leaner lean solvent stream to the extractor.

### EXAMPLE

This Example compares the process of the present invention, as described in FIG. 3 with the prior art process described in FIG. 2 with regard to their ability to processes a gas stream comprising methane and nitrogen by absorbing the methane away from the nitrogen in order to produce a methane stream that meets typical pipeline quality for inert content. The comparison is conducted under conditions such that a prior art process according to FIG. 1 produces a methane stream containing too much nitrogen to meet pipeline specification, i.e., under conditions such that a process according to FIG. 2 would typically be used to decrease the amount of nitrogen in the product stream. However, as indicated below, the inventive process of FIG. 3 can produce an identical quality product while eliminating the need for a dedicated flash recycle compressor to recycle a nitrogen rich stream (component 16 of FIG. 2). In other words, the process of the present invention achieves the same separation using a simpler process and fewer pieces of equipment than the process of FIG. 2.

The feed gas composition is 31% molar nitrogen and 69% molar methane and has a flow rate of 3.00 MMscfd, temperature of 100° F., and pressure of 600 psig. Normal octane is the solvent. The feed gas and the solvent are both chilled to −10° F. The processes of FIG. 2 and FIG. 3 result in essentially identical recovery of methane as a saleable pipeline quality gas. Both processes achieve 97.3% recovery of the valuable methane. The methane-rich product stream from both processes contains only 3.8% nitrogen.

All of the methods and apparatus disclosed herein can be made and executed without undue experimentation in light of the present disclosure. While the methods of this invention have been described in terms of specific embodiments, it will be apparent to those of skill in the art that variations may be applied to the methods and apparatus and in the steps or in the sequence of steps of the methods described herein without departing from the concept, spirit and scope of the invention. All such similar substitutes and modifications apparent to those skilled in the art are deemed to be within the spirit, scope and concept of the invention as defined by the appended provisional claims.

What is claimed is:

1. A process for separating the components of a multi-component gas stream, the process comprising:
contacting the multi-component gas stream with a solvent in an extractor to produce an overhead stream that is enriched in at least one unabsorbed component gas and a rich solvent bottoms stream that is enriched in at least one absorbed component gas;
flashing the rich solvent bottoms stream in at least one reduced pressure stage to regenerate lean solvent and to produce an overhead stream that is enriched in the at least one absorbed component gas;
recycling the regenerated lean solvent to the extractor;
compressing the overhead stream that is enriched in the at least one absorbed component gas to produce a product stream; and
recycling a portion of the product stream to the extractor.

2. The process of claim 1 wherein the multi-component gas stream comprises at least one hydrocarbon.

3. The process of claim 1, wherein the multi-component gas stream comprises one or more components selected from the group consisting of hydrogen, nitrogen, helium, argon, methane, ethylene, ethane, heavier saturated and unsaturated hydrocarbons and mixtures thereof.

4. The process of claim 1, wherein the unabsorbed component gas comprises nitrogen.

5. The process of claim 1, wherein the unabsorbed component gas comprises hydrogen.

6. The process of claim 1, wherein the product stream comprises methane.

7. The process of claim 1, wherein the solvent is one of the components of the multi-component gas stream.

8. The process of claim 1, wherein the solvent is an external solvent that is added to the process.

9. The process of claim 1, wherein the solvent is selected from the group consisting of paraffinic solvents, naphthenic solvents, and aromatic solvents.

10. The process of claim 1, wherein the extractor is a tower with internals to promote mass transfer.

11. The process of claim 1, wherein the multi-component gas stream is counter-currently contacted with the solvent.

12. The process of claim 1, wherein the recycled portion of the product stream is introduced to the extractor at a point in the extractor below where the multi-component gas stream enters the extractor.

13. The process of claim 1, further comprising providing a portion of the overhead stream that is enriched in at least one unabsorbed component gas to the at least one reduced pressure stage as a stripping gas.

14. An apparatus for separating the components of a multi-component gas stream, the apparatus comprising:
an extractor for contacting the multi-component gas stream with a solvent to produce an overhead stream that is enriched in at least one unabsorbed component gas and a rich solvent bottoms stream that is enriched in at least absorbed component gas;
at least one reduced pressure stage for flashing the rich solvent bottoms stream to regenerate lean solvent and to produce an overhead stream that is enriched in the at least one absorbed component gas;
piping suitable to recycle the regenerated lean solvent back to the extractor;
a compressor for compressing the overhead stream that is enriched in at least one absorbed component gas to produce a product stream; and
piping suitable for recycling a portion of the product stream back to the extractor.

15. The apparatus of claim 14, wherein the extractor is a tower with internals to promote mass transfer.

16. The apparatus of claim 14, wherein the multi-component gas stream is counter-currently contacted with the solvent.

17. The apparatus of claim 14, wherein the piping suitable for recycling a portion of the product stream back to the extractor enters the extractor a point below where the multi-component gas stream enters the extractor.

18. The apparatus of claim 14, further comprising piping suitable for providing a portion of the overhead stream that is enriched in at least one unabsorbed component gas to the at least one reduced pressure stage as a stripping gas.
